(19) United States
(12) Patent Application Publication
(10) Pub. No.: US 2007/0278821 A1
(43) Pub. Date: Dec. 6, 2007

(54) Wind deflector and screened ventilation system with cigarette egress passageway

(76) Inventor: Mike Peterson, Bloomingdale, OH (US)

Correspondence Address: GALLAGHER & DAWSEY CO., L.P.A., P.O. BOX 785, COLUMBUS, OH, 43216, US

(21) Appl. No.: 11/445,700

(22) Filed: Jun. 2, 2006

(51) Int. Cl. B60J 1/20

(52) U.S. Cl. 296/152

(57) ABSTRACT

A wind deflector and screened ventilation system with cigarette egress passageway is designed to releasably attach to a vehicle door. The device includes a deflector, screen, and cigarette egress passageway. The deflector has a deflector attachment portion and a wind deflection portion. The wind deflection portion includes a wind deflection portion proximal edge projection distance. The deflector attachment portion releasably attaches the deflector to the vehicle door, while the wind deflection portion deflects wind. The screen has a screen attachment portion and a screen ventilation portion. The screen ventilation portion includes a screen ventilation portion proximal edge projection distance. The screen attachment portion releasably attaches the screen to the deflector. A cigarette egress passageway is formed in the screen to permit a cigarette to pass from a screen ventilation portion interior surface to a screen ventilation portion exterior surface.

### TECHNICAL FIELD

The instant invention relates to motor vehicle accessories, and more particularly, to a wind deflector and screened ventilation system with cigarette egress passageway that easily attaches to a vehicle door, which thereby allows fresh air to circulate through the passenger compartment of the vehicle, prevents entry into the passenger compartment of outside debris, and provides a smoker-friendly system that enables passengers who are smoking cigarettes to more safely dispose of their cigarette ash.

### BACKGROUND OF THE INVENTION

Wind deflectors, or vent visors, as they are sometimes referred to, have been a popular motor vehicle accessory for many years. The success of the wind deflector stems from the fact that it provides several benefits to motor vehicle passengers.

One of the benefits achieved by the wind deflector is apparent when the vehicle is operated during a rain shower. In this situation, the deflector operates to prevent rain from entering the passenger compartment of the vehicle. This benefit is especially advantageous for those motor vehicle operators who smoke and prefer to dispose of their cigarette ash outside the vehicle window.

Another advantage of the wind deflector is that it decreases the noise level created by the wind while driving a motor vehicle with the windows slightly open. A further benefit of the wind deflector is heat dissipation. The wind deflector allows a motor vehicle operator to slightly open the windows of a parked vehicle, thereby dissipating heat and preventing the “greenhouse effect” experienced by many motor vehicle operators who enter their vehicle on a hot summer day. In this same capacity, the wind deflector can prevent a human or animal passenger from suffocating by providing adequate ventilation into the passenger compartment.

A final benefit of the wind deflector is that it allows fresh air to circulate within the passenger compartment of a motor vehicle no matter what the weather conditions may be. This can be helpful if a passenger in a motor vehicle is smoking, but the other passengers would prefer not to inhale the second-hand smoke. The fresh air circulating through the passenger compartment will help to displace the smoke contaminated air, thus providing a more enjoyable passenger compartment.

The typical wind deflector is made of acrylic, although deflectors may conceivably be manufactured from various other plastics and lightweight metals. Wind deflectors are designed to easily attach to a vehicle door. Some wind deflectors mount directly to the frame using double-sided acrylic foam tape, while other deflectors are installed in the window channel.

Although the current art wind deflector provides several benefits, it also has several disadvantages. A primary disadvantage is that outside debris can easily enter the passenger compartment of a vehicle by virtue of the space created between the wind deflector and the open window. Another problem encountered with current wind deflectors is that they are not as smoker-friendly as they could be. For example, a safety issue arises from a motor vehicle passenger who is smoking and trying to dispose of their ash between the wind deflector and window. The air circulating into the passenger compartment may dislodge the burning cigarette from the passenger's grip, resulting in damage to the interior of the vehicle, or even worse, burns to a passenger within the vehicle.

There remains an unfilled need to provide a wind deflector that retains the many benefits associated with current wind deflectors, yet is also more smoker-friendly and capable of preventing unwanted outside debris from entering a vehicle's passenger compartment.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

The present invention is a wind deflector and screened ventilation system with cigarette egress passageway. The wind deflector and screened ventilation system with cigarette egress passageway is configured to be releasably attached to a vehicle door.

The window deflector and screened ventilation system with cigarette egress passageway includes a deflector, a screen, and a cigarette egress passageway. The deflector has a deflector attachment portion and a wind deflection portion. The deflector attachment portion provides the means for mounting the window deflector and screened ventilation system with cigarette egress passageway to a frame of the vehicle door.

The screen is releasably attached to the deflector and includes a screen attachment portion and a screen ventilation portion. The screen attachment portion provides means for releasably attaching the screen to the deflector.

The screen ventilation portion cooperates with a window to provide an air-permeable barrier to the passenger compartment of the vehicle. The cooperation between the screen ventilation portion and the window allows the window to be in an open position while the screen ventilation portion lets fresh air into the passenger compartment of the vehicle and prevents insects, debris, and the like from entering the passenger compartment of the vehicle.

The present invention further includes a cigarette egress passageway formed in the screen. The cigarette egress passageway has an egress perimeter configured to permit a cigarette to pass from a screen ventilation portion interior surface to a screen ventilation portion exterior surface. Furthermore, the configuration of the cigarette egress passageway in the screen is such that the window need not be lowered below the screen before the cigarette egress passageway may be utilized. This feature allows the window and the screen ventilation portion to remain in cooperation with one another, creating an air-permeable barrier to the vehicle's passenger compartment. Thus, a passenger who is smoking a cigarette and wishes to dispose of their ash outside of the vehicle may do so with a substantially decreased likelihood that outside debris will enter the vehicle's passenger compartment.

The system of the instant invention enables a significant advance in the state of the art. The instant invention is, in addition, widely applicable to a large number of applications. Variations, modifications, alternatives, and alterations of the various preferred embodiments may be used alone or in combination with one another, as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 is an elevation view of an embodiment of the wind deflector and screened ventilation system with cigarette egress passageway attached to a vehicle door, not to scale;

FIG. 2 is an elevation view of a vehicle door, not to scale;

FIG. 3 is an elevation view of a vehicle door window, not to scale;

FIG. 4 is a cross-sectional view of a vehicle door frame and window, showing the window in a slightly open position, not to scale;

FIG. 5 is a cross-sectional view of the vehicle door taken along section line 5-5 of FIG. 2, showing the window in a sealed position, not to scale;

FIG. 6 is a cross-sectional view of a vehicle door frame and window, showing the window in a position between the sealed position and the open position, not to scale;

FIG. 7 is a cross-sectional view of an embodiment of the deflector of the wind deflector and screened ventilation system with cigarette egress passageway, not to scale;

FIG. 8 is a cross-sectional view of an embodiment of the wind deflector and screened ventilation system with cigarette egress passageway, not to scale;

FIG. 9 is a cross-sectional view of an embodiment of the wind deflector and screened ventilation system with cigarette egress passageway attached to a vehicle door, showing the window in an open position, not to scale;

FIG. 10 is a cross-sectional view of an embodiment of the wind deflector and screened ventilation system with cigarette egress passageway attached to a vehicle door, showing the window in the sealed position, not to scale;

FIG. 11 is a cross-sectional view of an embodiment of the wind deflector and screened ventilation system with cigarette egress passageway attached to a vehicle door, showing the window in the sealed position, not to scale;

FIG. 12 is an elevation view of a vehicle door with an embodiment of the screen of the wind deflector and screened ventilation system with cigarette egress passageway attached to the vehicle door, not to scale;

FIG. 13 is a cross-sectional view of the vehicle door with an embodiment of the screen of the wind deflector and screened ventilation system with cigarette egress passageway attached to the vehicle door taken along section line 13-13 of FIG. 12, illustrating a cigarette passing through the cigarette egress passageway, not to scale;

FIG. 14 is an elevation view of an embodiment of the screen of the wind deflector and screened ventilation system with cigarette egress passageway, not to scale;

FIG. 15 is an elevation view of an embodiment of the screen of the wind deflector and screened ventilation system with cigarette egress passageway, not to scale;

FIG. 16 is an elevation view of an embodiment of the screen of the wind deflector and screened ventilation system with cigarette egress passageway, not to scale;

FIG. 17 is an elevation view of an embodiment of the screen of the wind deflector and screened ventilation system with cigarette egress passageway, not to scale;

FIG. 18 is a cross-sectional view of an embodiment of the wind deflector and screened ventilation system with cigarette egress passageway attached to a vehicle door, showing the window in an open position, not to scale;

FIG. 19 is an elevation view of an embodiment of the screen of the wind deflector and screened ventilation system with cigarette egress passageway, not to scale; and

FIG. 20 is an elevation view of an embodiment of the screen of the wind deflector and screened ventilation system with cigarette egress passageway, not to scale.

### DETAILED DESCRIPTION OF THE INVENTION

The wind deflector and screened ventilation system with cigarette egress passageway (200) of the instant invention enables a significant advance in the state of the art. The preferred embodiments of the device accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

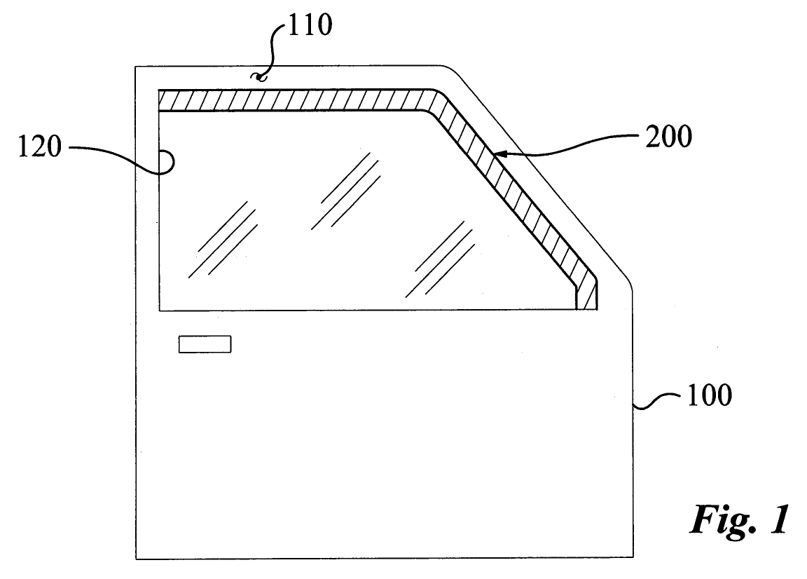

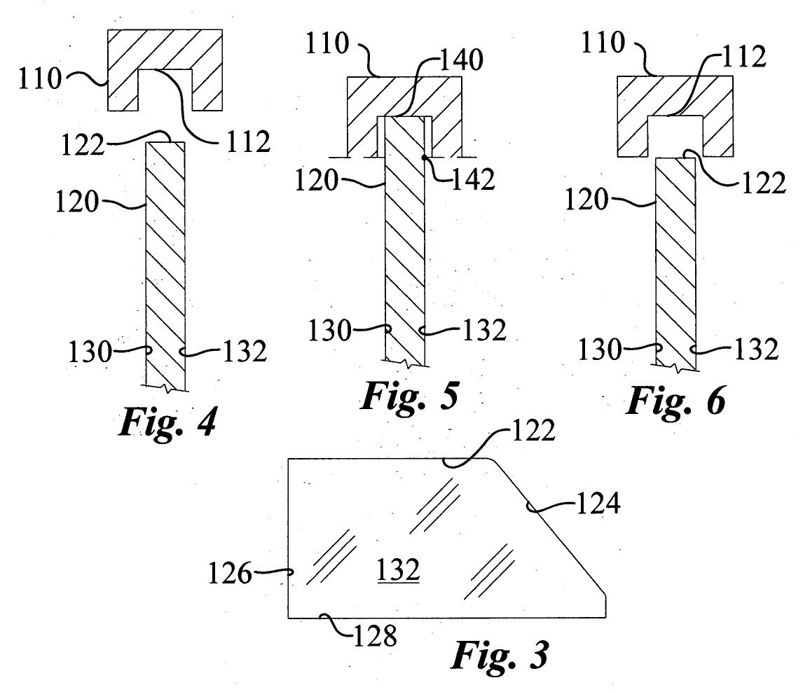

Referring now generally to FIGS. 1 through 20, the present invention is a wind deflector and screened ventilation system with cigarette egress passageway (200). The device may generally be described as having a deflector (300), a screen (400), and a cigarette egress passageway (500).

In one embodiment, as seen in FIG. 1, the wind deflector and screened ventilation system with cigarette egress passageway (200) is shown attached to a vehicle door (100). Although FIG. 1 shows the wind deflector and screened ventilation system with cigarette egress passageway (200) on a front passenger side door, one skilled in the art would recognize that the wind deflector and screened ventilation system with cigarette egress passageway (200) of the present invention can be attached to the front driver side door, as well as both the driver and passenger side rear doors. One skilled in the art would also recognize that the wind deflector and screened ventilation system with cigarette egress passageway (200) of the present invention can be manufactured to be compatible with a multitude of different vehicle door and window configurations. Furthermore, the wind deflector and screened ventilation system with cigarette egress passageway (200) may be available as an aftermarket kit or as a vehicle's original equipment manufacturer (“OEM”) part.

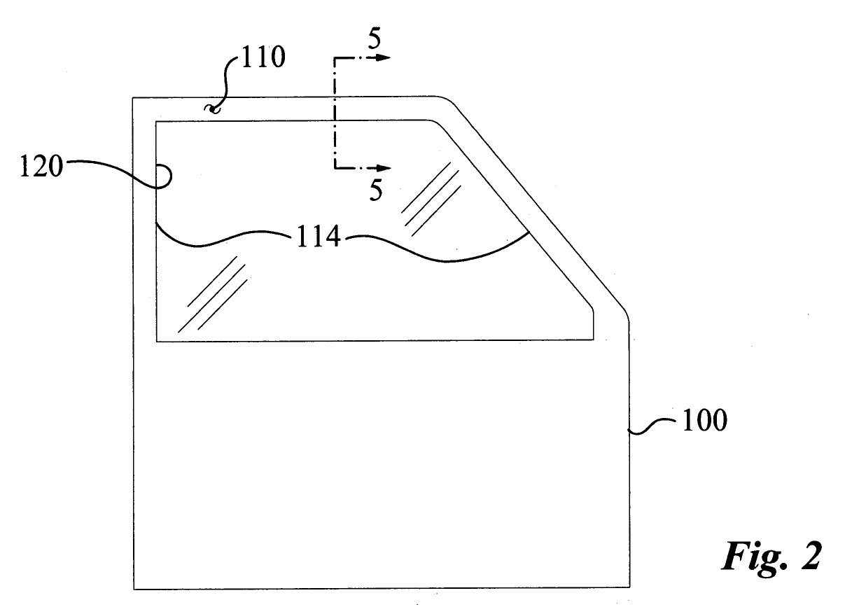

Referring generally to FIGS. 2-6, the vehicle door (100) has a frame (110) and a window (120). The frame (110) has a window opening (114) and a window receiving channel (112). The window (120) has a top window edge (122), a leading window edge (124), a trailing window edge (126), a bottom window edge (128), an interior window surface (130), an exterior window surface (132), a sealed position (140), and a point of exposure (142). As best seen in FIG. 5, the window (120) is in the sealed position (140), which refers to the position where the top window edge (122) is securely seated within the window receiving channel (112). The sealed position (140) is also used to define the point of exposure (142). Again referring to FIG. 5, the point of exposure (142) is defined as the point on the exterior window surface (132) where the window (120) is first exposed to the outside elements when the window (120) is in the sealed position (140). The point of exposure (142) is used as a reference point to measure two distances, which will be described in detail below.

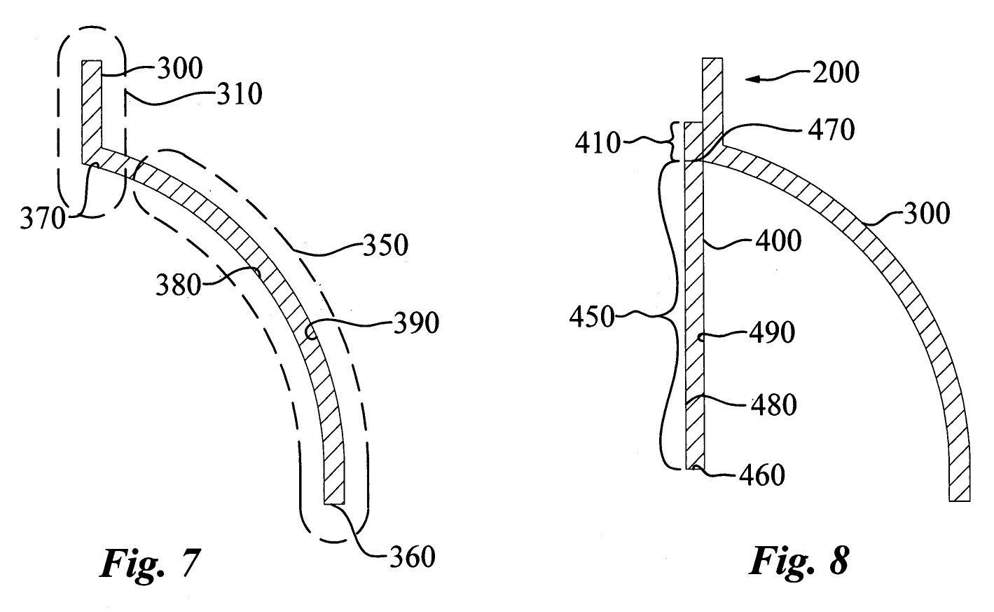

The window deflector and screened ventilation system with cigarette egress passageway (200) includes a deflector (300), a screen (400), and a cigarette egress passageway (500). As seen in FIG. 7, the deflector (300) has a deflector attachment portion (310) and a wind deflection portion (350). The deflector (300) serves as a type of weather guard to prevent rain and other inclement weather from entering the vehicle's passenger compartment when the windows are slightly opened. The deflector (300) may be formed from a variety of materials, including, but not limited to, aluminum, acrylic, and other types of plastics and metals. The deflector attachment portion (310) provides the means for mounting the window deflector and screened ventilation system with cigarette egress passageway (200) to the frame (110) of a vehicle door (100). In one embodiment of the instant invention, the deflector attachment portion (310) is a window channel cooperation member (320), as seen in FIG. 10. The window channel cooperation member (320) may be designed to fully seat within the window receiving channel (112), or alternatively, the window channel cooperation member (320) may only cooperate with a portion of the window receiving channel (112).

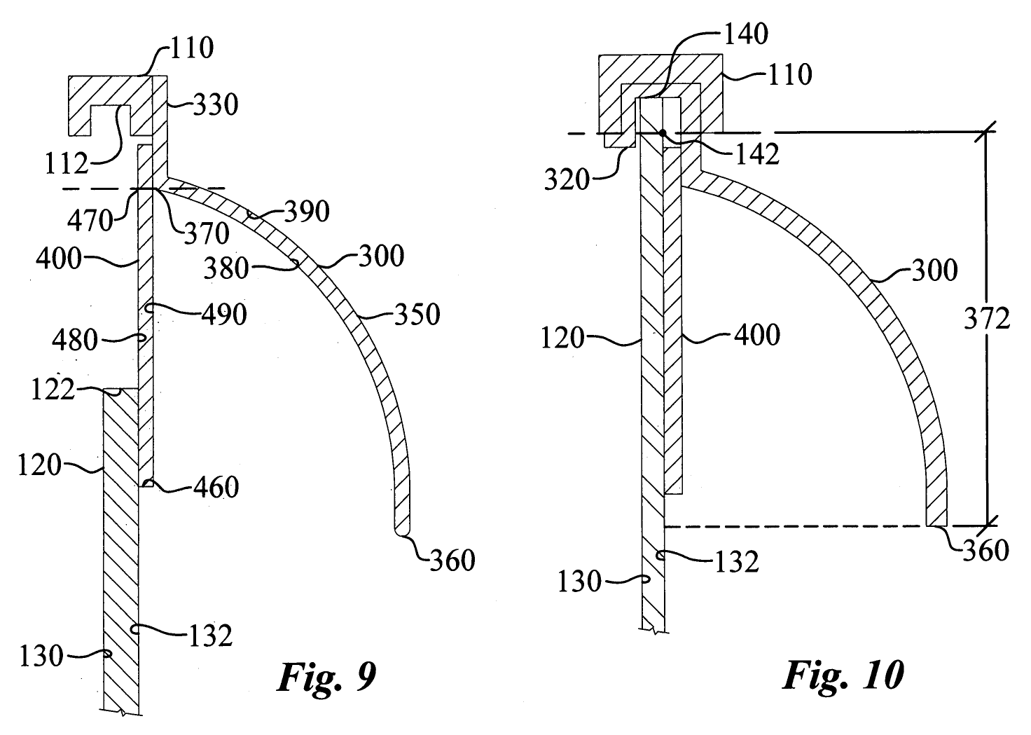

In another embodiment of the present invention, the deflector attachment portion (310) is a surface mounting flange (330), as seen in FIG. 9. The surface mounting flange (330) can be releasably attached to the frame (110) using any type of releasable attaching means including, but not limited to, two-sided acrylic foam tape, hook and loop fasteners, and plastic or metal clips, or combinations thereof.

Referring again to FIG. 7, the wind deflection portion (350) includes a wind deflection portion distal edge (360), a wind deflection portion proximal edge (370), and a wind deflection portion proximal edge projection distance (372). As seen in FIG. 10, the wind deflection proximal edge projection distance (372) is the longitudinal distance measured from the point of exposure (142) to the orthogonal projection of the wind deflection portion distal edge (360) on the exterior window surface (132). Furthermore, the wind deflection portion (350) projects outwardly from the door (100) to deflect wind. By way of example only, FIGS. 7-11 set forth a geometry of the wind deflection portion (350) as a half-semi-oval. However, those having skill in the art would recognize and appreciate that other geometries for the wind deflection portion (350) may be utilized.

With reference now to FIG. 8, the screen (400) is releasably attached to the deflector (300) and includes a screen attachment portion (410) and a screen ventilation portion (450). The screen (400) may be formed from a variety of materials, including, but not limited to, various types of plastic, wire mesh, natural fibers, and other materials suitable for functioning as an air-permeable screen. The screen attachment portion (410) provides means for releasably attaching the screen (400) to the deflector (300). The screen attachment portion (410) may be attached to the deflector by any type of releasable attaching means, including, but not limited to, nuts and bolts, hook and loop fasteners, plastic or metal clips, adhesives or bonding agents, and fusion techniques, or combinations thereof.

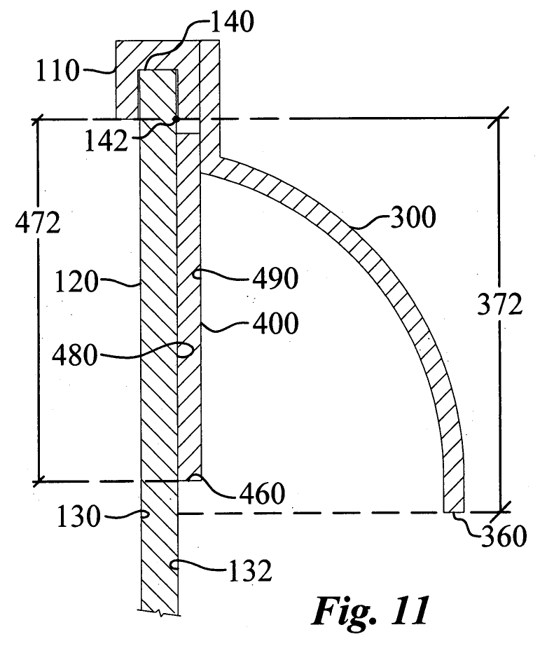

With continued reference to FIG. 8, the screen ventilation portion (450) has a screen ventilation portion distal edge (460), a screen ventilation portion proximal edge (470), a screen ventilation portion proximal edge projection distance (472), seen only in FIG. 11, a screen ventilation portion interior surface (480), and a screen ventilation portion exterior surface (490). The screen ventilation portion proximal edge (470) is represented by a dashed line perpendicular to the screen ventilation portion interior (480) and exterior (490) surfaces, approximately even with the wind deflection portion proximal edge (370). The screen ventilation portion proximal edge projection distance (472), as seen in FIG. 11, is the orthogonal distance measured from the point of exposure (142) to the screen ventilation portion distal edge (460) along the exterior window surface (132).

Referring generally to FIGS. 9-12, the screen ventilation portion (450) cooperates with the window (120) to provide an air-permeable barrier to the passenger compartment of a vehicle. The cooperation between the screen ventilation portion (450) and the window (120) allows the window (120) to be in an open position while the screen ventilation portion (450) lets fresh air into the passenger compartment of a vehicle and prevents insects, debris, and the like from entering the passenger compartment of the vehicle.

As seen in an embodiment of the instant invention in FIG. 1, the screen ventilation portion proximal edge projection distance (472) is less than the wind deflection portion proximal edge projection distance (362). While in other embodiments of the instant invention the screen ventilation portion proximal edge projection distance (472) may be a greater distance, the screen ventilation portion proximal edge projection distance (472) should be no more than the wind deflection portion proximal edge projection distance (372). Having a screen ventilation portion proximal edge projection distance (472) that is longer than the wind deflection portion proximal edge projection distance (372) would not be desirable. For example, if the screen ventilation portion proximal edge projection distance (472) was longer than the wind deflection portion proximal edge projection distance (372), then the shielding effect of the deflector (300) would be decreased and the possibility of rain, for example, entering a vehicle's passenger compartment would be greatly increased.

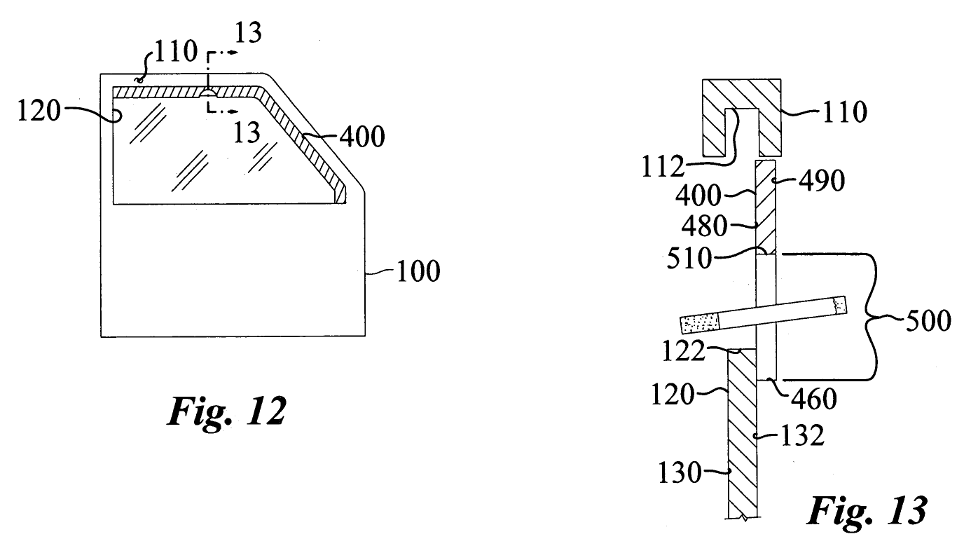

Referring now generally to FIGS. 12-17, a cigarette egress passageway (500) is formed in the screen (400). The cigarette egress passageway (500) has an egress perimeter (510) configured to permit a cigarette to pass from the screen ventilation portion interior surface (480) to the screen ventilation portion exterior surface (490), as seen in FIG. 13. Furthermore, the cigarette egress passageway (500) has a passageway length (550) and a passageway depth (560). In an embodiment of the instant invention, the passageway depth (560) is configured such that it is less than 75% of the screen ventilation portion proximal edge projection distance (472). In another embodiment of the present invention, the passageway length (550) is designed to be at least 7.62 centimeters (three inches). A passageway length (550) of at least 7.62 centimeters (three inches) is desirable due to the fact that the length of a typical cigarette measures anywhere from 8 to 10 centimeters (3.15 to 3.94 inches). Thus, a passageway length (550) of at least 7.62 centimeters (three inches) will allow the cigarette user to more effectively use the cigarette egress passageway (500) by decreasing the chance that a cigarette will unintentionally come into contact with a point on the egress perimeter (510), which can lead to cigarette burns on the cigarette user and cigarette burns to the interior of the vehicle.

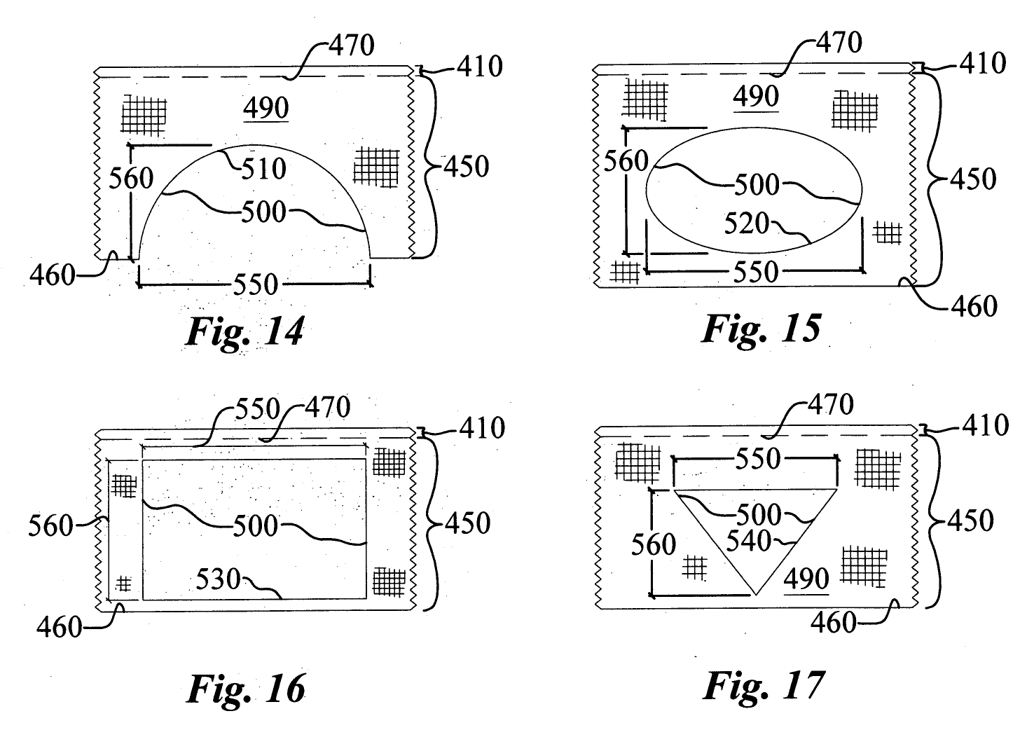

Referring now to FIG. 14, in one embodiment of the present invention, two points of the egress perimeter (510) are located on the screen ventilation portion distal edge (460) to form the cigarette egress passageway (500). Thus, in the embodiment seen in FIG. 14, the egress perimeter (510) is a concave notch in the screen ventilation portion (450) along the screen ventilation portion distal edge (460). As those skilled in the art will observe and appreciate, and by way of example and not limitation, the egress perimeter (510) may be formed using a variety of different geometries, such as a semi-oval, rectangle, square, or triangle, just to name a few.

In another embodiment of the present invention, the cigarette egress passageway (500) is disposed between the screen ventilation portion distal edge (460) and the screen ventilation portion proximal edge (470), as seen generally in FIGS. 15-17. Thus, in this embodiment the cigarette egress passageway (500) is a dedicated penetration through the screen (400) located between the screen ventilation portion distal (460) and proximal (470) edges. In one embodiment of the invention, the cigarette egress passageway (500) is defined by an oval perimeter (520), as seen in FIG. 15. Referring now to FIG. 16, another embodiment of the present invention is shown with the cigarette egress passageway (500) having a rectangular perimeter (530). In still another embodiment of the instant invention, as seen in FIG. 17, the cigarette egress passageway (500) is defined by a triangular perimeter (540).

The geometries of the egress perimeter (510) can be chosen based on functional or aesthetic value. For example, the triangular perimeter (540), as seen in FIG. 17, allows for the window (120) to be open a minimal distance while providing a maximum passageway length (550). Furthermore, when the window (120) is below the entire triangular perimeter (540), the bottom point of the triangular perimeter (540) provides a wedge that the cigarette user may rest his or her cigarette in. However, the triangular perimeter (540) seen in FIG. 17 may also be rotated 180° such that the base of the triangular perimeter is closer to the screen ventilation portion distal edge (460). This particular geometry (not shown) creates a gradually increasing passageway length (550) as the window (120) is further opened. On the other hand, the rectangular perimeter (530), as seen in FIG. 16, maintains a constant maximum passageway length (550), but the passageway depth (560) increases as the window (120) is lowered. The oval perimeter (520), shown in FIG. 15, provides a maximum passageway length (550) when the window (120) has moved below the top-half of the oval perimeter (520).

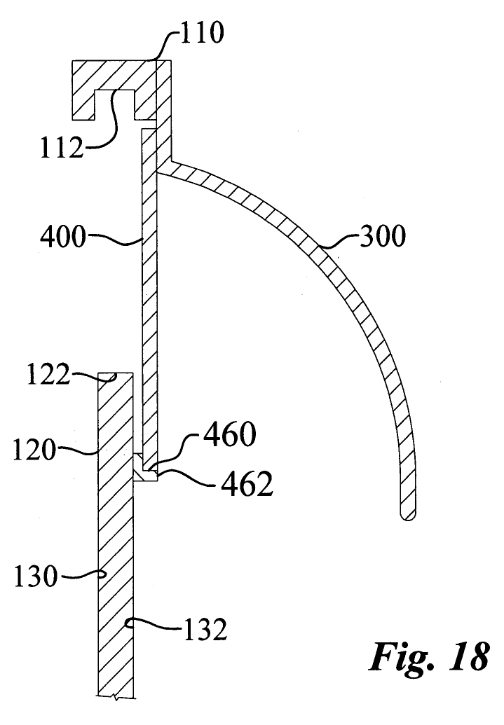

In another embodiment of the present invention, a screen gasket (462) is releasably attached to the screen ventilation portion distal edge (460), as seen in FIG. 18. The screen gasket (462) provides means for allowing the screen (400) to form a tighter seal against the exterior window surface (132), thus preventing the chance that outside objects might enter into a vehicle's passenger compartment between the screen (400) and window (120). The screen gasket (462) provides a further benefit in that it allows the screen (400) to cooperate more smoothly along the exterior window surface (132) and also prevents the screen (400) from scratching the exterior window surface (132). The screen gasket (462) may be made from a wide variety of materials, including, but not limited to, rubber, plastic, silicone, PTFE, and various types of elastomers.

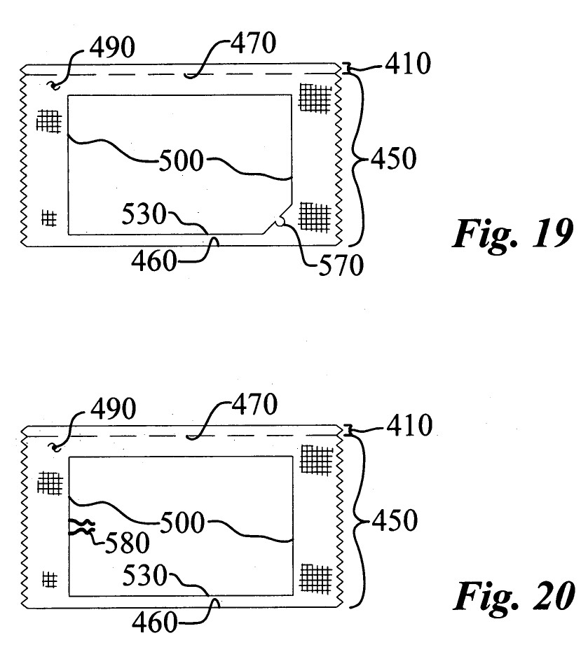

In still another embodiment of the present invention, the egress perimeter (510) may be configured to have a cigarette retaining recess (570), as seen in FIG. 19, which shows a rectangular perimeter (530). The cigarette retaining recess (570) provides passengers with a notch, which may be used to secure their cigarette while they are not smoking. Referring now to FIG. 20, another embodiment of the instant invention is shown with a cigarette holding clip (580) releasably attached to the screen (400). The cigarette holding clip (580) is configured to releasably secure a cigarette when not being used. The cigarette holding clip (580) may be formed from a variety of materials, including, but not limited to, various plastics and lightweight metals.

Although the instant invention is described as having a deflector (300), one having skill in the art would immediately recognize and appreciate that the wind deflector and screened ventilation system with cigarette egress (200) would retain several of its beneficial attributes with the deflector (300) removed, but overall would be less effective for its intended purpose.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. A wind deflector and screened ventilation system with cigarette egress passageway (200) for a vehicle door (100) having a frame (110) and a window (120), the frame (110) having a window receiving channel (112) and a window opening (114), the window (120) having a sealed position (140), a point of exposure (142), and an exterior window surface (132), the wind deflector and screened ventilation system with cigarette egress passageway (200) comprising:
(A) a deflector (300) having a deflector attachment portion (310) and a wind deflection portion (350), the wind deflection portion (350) having a wind deflection portion distal edge (360) and a wind deflection portion proximal edge (370), and a wind deflection portion proximal edge projection distance (372) defined by the longitudinal distance from the point of exposure (142) to the orthogonal projection of the wind deflection portion distal edge (360) on the exterior window surface (132), wherein,
(i) the deflector attachment portion (310) releasably attaches the deflector (300) to the frame (110), and
(ii) the wind deflection portion (350) projects outwardly from the door (100) to deflect wind;
(B) a screen (400) having a screen attachment portion (410) and a screen ventilation portion (450), the screen ventilation portion (450) having a screen ventilation portion distal edge (460) and a screen ventilation portion proximal edge (470), a screen ventilation portion proximal edge projection distance (472) defined by the orthogonal distance from the point of exposure (142) to the screen ventilation portion distal edge (460) along the exterior window surface (132), a screen ventilation portion interior surface (480), and a screen ventilation portion exterior surface (490), wherein,
(i) the screen attachment portion (410) releasably attaches the screen (400) to the deflector (300),
(ii) the screen ventilation portion (450) cooperates with the window (120), and
(iii) the screen ventilation portion proximal edge projection distance (472) is no more than the wind deflection portion proximal edge projection distance (362); and
(C) a cigarette egress passageway (500) formed in the screen (400), wherein the cigarette egress passageway (500) has an egress perimeter (510) configured to permit a cigarette to pass from the screen ventilation portion interior surface (480) to the screen ventilation portion exterior surface (490).

2. The wind deflector and screened ventilation system with cigarette egress passageway (200) of claim 1, wherein two points of the egress perimeter (510) are disposed along the screen ventilation portion distal edge (460).

3. The wind deflector and screened ventilation system with cigarette egress passageway (200) of claim 2, wherein the cigarette egress passageway (500) has a passageway length (570) and a passageway depth (580), and the passageway depth (580) is less than 75% of the screen ventilation portion proximal edge projection distance (472).

4. The wind deflector and screened ventilation system with cigarette egress passageway (200) of claim 2, wherein the cigarette egress passageway (500) has a passageway length (570) and a passageway depth (580), and the passageway length (570) is at least three inches.

5. The wind deflector and screened ventilation system with cigarette egress passageway (200) of claim 1, wherein the cigarette egress passageway (500) is disposed between the screen ventilation portion distal edge (460) and the screen ventilation portion proximal edge (470).

6. The wind deflector and screened ventilation system with cigarette egress passageway (200) of claim 5, wherein the cigarette egress passageway (500) has a passageway length (570) and a passageway depth (580), and the passageway depth (580) is less than 75% of the screen ventilation portion proximal edge projection distance (472).

7. The wind deflector and screened ventilation system with cigarette egress passageway (200) of claim 5, wherein the cigarette egress passageway (500) has a passageway length (570) and a passageway depth (580), and the passageway length (570) is at least three inches.

8. The wind deflector and screened ventilation system with cigarette egress passageway (200) of claim 5, wherein the cigarette egress passageway (500) is formed as an oval perimeter (520).

9. The wind deflector and screened ventilation system with cigarette egress passageway (200) of claim 5, wherein the cigarette egress passageway (500) is formed as a rectangular perimeter (530).

10. The wind deflector and screened ventilation system with cigarette egress passageway (200) of claim 5, wherein the cigarette egress passageway (500) is formed as a triangular perimeter (540).

11. The wind deflector and screened ventilation system with cigarette egress passageway (200) of claim 1, wherein the deflector attachment portion (310) includes a window channel cooperation member (320).

12. The wind deflector and screened ventilation system with cigarette egress passageway (200) of claim 1, wherein the deflector attachment portion (310) includes a surface mounting flange (330).

13. A wind deflector and screened ventilation system with cigarette egress passageway (200) for a vehicle door (100) having a frame (110) and a window (120), the frame (110) having a window receiving channel (112) and a window opening (114), the window (120) having a sealed position (140), a point of exposure (142), a top window edge (122) and an exterior window surface (132), the wind deflector and screened ventilation system with cigarette egress passageway (200) comprising:
(A) a deflector (300) having a deflector attachment portion (310) and a wind deflection portion (350), the wind deflection portion (350) having a wind deflection portion distal edge (360) and a wind deflection portion proximal edge (370), and a wind deflection portion proximal edge projection distance (372) defined by the longitudinal distance from the point of exposure (142) to the orthogonal projection of the wind deflection portion distal edge (360) on the exterior window surface (132), wherein,
(i) the deflector attachment portion (310) releasably attaches the deflector (300) to the frame (110), and
(ii) the wind deflection portion (350) projects outwardly from the door (100) to deflect wind;
(B) a screen (400) having a screen attachment portion (410) and a screen ventilation portion (450), the screen ventilation portion (450) having a screen ventilation portion distal edge (460) and a screen ventilation portion proximal edge (470), a screen ventilation portion proximal edge projection distance (472) defined by the orthogonal distance from the point of exposure (142) to the screen ventilation portion distal edge (460) along the exterior window surface (132), a screen ventilation portion interior surface (480), and a screen ventilation portion exterior surface (490), wherein,
(i) the screen attachment portion (410) releasably attaches the screen (400) to the deflector (300),
(ii) the screen ventilation portion (450) cooperates with the window (120), and
(iii) the screen ventilation portion proximal edge projection distance (472) is no more than the wind deflection portion proximal edge projection distance (362);
(C) a cigarette egress passageway (500) formed in the screen (400), wherein,
(i) the cigarette egress passageway (500) has an egress perimeter (510) configured to permit a cigarette to pass from the screen ventilation portion interior surface (480) to the screen ventilation portion exterior surface (490); and
(ii) two points of the egress perimeter (510) are disposed along the screen ventilation portion distal edge (460).

14. The wind deflector and screened ventilation system with cigarette egress passageway (200) of claim 13, wherein the cigarette egress passageway (500) has a passageway length (570) and a passageway depth (580), and the passageway depth (580) is less than 75% of the screen ventilation portion proximal edge projection distance (472).

15. The wind deflector and screened ventilation system with cigarette egress passageway (200) of claim 13, wherein the cigarette egress passageway (500) has a passageway length (570) and a passageway depth (580), and the passageway length (570) is at least three inches.

16. A wind deflector and screened ventilation system with cigarette egress passageway (200) for a vehicle door (100) having a frame (110) and a window (120), the frame (110) having a window receiving channel (112) and a window opening (114), the window (120) having a sealed position (140), a point of exposure (142), and an exterior window surface (132), the wind deflector and screened ventilation system with cigarette egress passageway (200) comprising:
(A) a deflector (300) having a deflector attachment portion (310) and a wind deflection portion (350), the wind deflection portion (350) having a wind deflection portion distal edge (360) and a wind deflection portion proximal edge (370), and a wind deflection portion proximal edge projection distance (372) defined by the longitudinal distance from the point of exposure (142) to the orthogonal projection of the wind deflection portion distal edge (360) on the exterior window surface (132), wherein,
(i) the deflector attachment portion (310) releasably attaches the deflector (300) to the frame (110), and
(ii) the wind deflection portion (350) projects outwardly from the door (100) to deflect wind;
(B) a screen (400) having a screen attachment portion (410) and a screen ventilation portion (450), the screen ventilation portion (450) having a screen ventilation portion distal edge (460) and a screen ventilation portion proximal edge (470), a screen ventilation portion proximal edge projection distance (472) defined by the orthogonal distance from the point of exposure (142) to the screen ventilation portion distal edge (460) along the exterior window surface (132), a screen ventilation portion interior surface (480), and a screen ventilation portion exterior surface (490), wherein,
(i) the screen attachment portion (410) releasably attaches the screen (400) to the deflector (300),
(ii) the screen ventilation portion (450) cooperates with the window (120), and
(iii) the screen ventilation portion proximal edge projection distance (472) is no more than the wind deflection portion proximal edge projection distance (362);
(C) a cigarette egress passageway (500) formed in the screen (400), wherein,
(i) the cigarette egress passageway (500) has an egress perimeter (510) configured to permit a cigarette to pass from the screen ventilation portion interior surface (480) to the screen ventilation portion exterior surface (490), and
(ii) the cigarette egress passageway (500) is disposed between the screen ventilation portion distal edge (460) and the screen ventilation portion proximal edge (470).

17. The wind deflector and screened ventilation system with cigarette egress passageway (200) of claim 16, wherein the cigarette egress passageway (500) has a passageway length (570) and a passageway depth (580), and the passageway depth (580) is less than 75% of the screen ventilation portion proximal edge projection distance (472).

18. The wind deflector and screened ventilation system with cigarette egress passageway (200) of claim 16, wherein the cigarette egress passageway (500) has a passageway length (570) and a passageway depth (580), and the passageway length (570) is at least three inches.

19. The wind deflector and screened ventilation system with cigarette egress passageway (200) of claim 16, wherein the cigarette egress passageway (500) is formed as an oval perimeter (520).

20. The wind deflector and screened ventilation system with cigarette egress passageway (200) of claim 16, wherein the cigarette egress passageway (500) is formed as a rectangular perimeter (530).
